(19) United States
(12) Patent Application Publication
(10) Pub. No.: US 2013/0239821 A1
(43) Pub. Date: Sep. 19, 2013

(54) Container with Removable Bottom Tea Infuser

(71) Applicant: ERIK STEPHEN BOETTCHER, Frederick, MD (US)

(72) Inventor: ERIK STEPHEN BOETTCHER, Frederick, MD (US)

(21) Appl. No.: 13/786,854

(22) Filed: Mar. 6, 2013

Related U.S. Application Data
(60) Provisional application No. 61/611,921, filed on Mar. 16, 2012.

(51) Int. Cl. A47J 31/20

(52) U.S. Cl. CPC A47J 31/20
USPC 99/317

(57) ABSTRACT

A cylindrical travel mug or container with or without a handle and drinking top/lid, lower tea compartment housing with one or more mesh screens, and removable bottom. The removable bottom is comprised of a threaded base bap, rubber seal, conical tea compartment for retaining a tea bag and an on/off control knob. The tea compartment is connected to the base with a press release that allows it to swing open against an opposing hinge from the release so a tea bag can be inserted or removed. The conical tea compartment is further comprised of one or more mesh openings through which liquid and tea may be transferred. An on/off control switch is used to rotate the tea compartment and its mesh screens with respect to the tea compartment housing and its mesh screens to enable control of the starting and stopping of tea infusion or steeping.

### CROSS REFERENCE TO RELATED APPLICATIONS

This application claims priority from U.S. Patent Application Ser. No. 61/611,921, entitled “Container with Removable Bottom Tea Infuser”, filed on Mar. 16, 2012. The benefit under 35 USC §119(e) of the United States provisional application is hereby claimed, and the aforementioned application is hereby incorporated herein by reference.

### FEDERALLY SPONSORED RESEARCH

Not Applicable

### SEQUENCE LISTING OR PROGRAM

Not Applicable

### TECHNICAL FIELD OF THE INVENTION

The present invention relates generally to a container. More specifically, the present invention relates to a container for brewing tea.

### BACKGROUND OF THE INVENTION

When brewing tea, a tea bag is commonly placed into a container with hot water so the tea bag can steep with the hot water, releasing the flavor and fragrance. In other devices known in the prior art, tea leaves are retained in a filter within the container. The problem with using tea bags or a filter, is that during travel, the steeping time can not be controlled and in the case of a tea bag, discarding the tea bag can be a hassle or nuisance to the user who has no place to discard the used tea bag when steeping is complete.

Therefore, what is needed is a new container design that allows for the use of a tea bag or tea leaves and filter which can control the steeping time of the tea bag or leaves and provides a convenient means for storing the tea bag or leaves until it is convenient for them to be discarded.

The present invention overcomes the disadvantages of a conventional container for brewing tea and storing it for consumption during travel.

### SUMMARY OF THE INVENTION

The container of the present invention is assembled from a shaft with an interior and exterior surface, the exterior surface which may or may not have a handle molded or affixed to it. The interior surface of the shaft defines the liquid storage area from which a person would drink a liquid. The top of the shaft may or may not be covered with a top cap.

The top cap covers the opening of the drinking end of the shaft and the top cap is further comprised of a small drinking opening similar to other caps known in the prior art for hot liquids such as tea or hot chocolate. The opposing end of the shaft from the drinking or top end is the base end. The base end is comprised of a tea compartment housing which may or may not be molded into the shaft. The tea compartment housing creates a space for a tea compartment to be retained when a base cap is secured to the shaft. The tea compartment housing is further comprised of wire mesh which matches the shape of wire mesh openings on the tea compartment.

A threaded base cap is secured to the base end of the shaft by corresponding threads that allow it to be screwed into the base end of the shaft. The threaded base cap includes a rubber seal to stop leaks of the liquid placed within the shaft. The threaded base cap is further comprised of the tea compartment attached on one end, which, when the base cap is attached to the shaft, protrudes into the tea compartment housing.

An on/off control switch located on the bottom side of the base cap and opposite the tea compartment is used to rotate the tea compartment and its mesh screens with respect to the tea compartment housing and its mesh screens to enable control of and the starting and stopping of tea infusion or steeping.

### BRIEF DESCRIPTION OF THE DRAWINGS

The accompanying drawings, which are incorporated herein an form a part of the specification, illustrate the present invention and, together with the description, further serve to explain the principles of the invention and to enable a person skilled in the pertinent art to make and use the invention.

FIG. 1 is a perspective view of the container of the present invention assembled and ready for use;

FIG. 2 is an exploded view of the container of the present invention illustrating all the components parts of the device and their order of assembly;

FIG. 3 is planar exploded view of the container of the present invention illustrating the dimensions of the components of the parts of the device;

FIG. 4 is a perspective, operational view of the container of the present invention illustrating the removal of the bottom portion by unscrewing the base cap from the bottom;

FIG. 5 is a perspective view of the container of the present invention illustrating the base cap removed from the shaft;

FIG. 6 is a perspective view of the base cap illustrating the cone release from a closed position;

FIG. 7 is a perspective view of the base cap illustrating the cone released into an open position;

FIG. 8 is a perspective view of the base cap illustrating the cone released into an open position and the insertion of the tea bag into the opened cone;

FIG. 9 is a perspective view of the base cap illustrating the cone being moved from an open position to a closed position and snapped into place;

FIG. 10 is a perspective view of the container of the present invention illustrating the base cap with tea bag being reinserted into the shaft;

FIG. 11 is a perspective, operational view of the container of the present invention illustrating the attachment of the bottom portion by screwing the base cap into the shaft;

FIG. 12 is a perspective, cut away view, illustrating the base cap attached to the shaft and the tea bag located inside the cone;

FIG. 13 is a perspective, operational view of the bottom of the container and the on/off control;

FIG. 14a is a perspective, cut away view, illustrating the relationship between the tea compartment and tea compartment housing of the shaft when the on/off control is placed in a closed/off position;

FIG. 14b is a perspective, operational view of the bottom of the container and the on/off control paced in the closed/off position;

FIG. 15a is a perspective, cut away view, illustrating the relationship between the tea compartment and tea compartment housing of the shaft when the on/off control is moved into an open/on position;

FIG. 15b is a perspective, operational view of the bottom of the container and the on/off control is moved into an open/on position;

FIG. 16a is a perspective, cut away view, illustrating the relationship between the tea compartment and tea compartment housing of the shaft when the on/off control is placed in an open/on position; and

FIG. 16b is a perspective, operational view of the bottom of the container and the on/off control paced in the open/on position.

### DETAILED DESCRIPTION OF THE INVENTION

In the following detailed description of the invention of exemplary embodiments of the invention, reference is made to the accompanying drawings (where like numbers represent like elements), which form a part hereof, and in which is shown by way of illustration specific exemplary embodiments in which the invention may be practiced. These embodiments are described in sufficient detail to enable those skilled in the art to practice the invention, but other embodiments may be utilized and logical, mechanical, electrical, and other changes may be made without departing from the scope of the present invention. The following detailed description is, therefore, not to be taken in a limiting sense, and the scope of the present invention is defined only by the appended claims.

In the following description, numerous specific details are set forth to provide a thorough understanding of the invention. However, it is understood that the invention may be practiced without these specific details. In other instances, well-known structures and techniques known to one of ordinary skill in the art have not been shown in detail in order not to obscure the invention. Referring to the figures, it is possible to see the various major elements constituting the apparatus of the present invention.

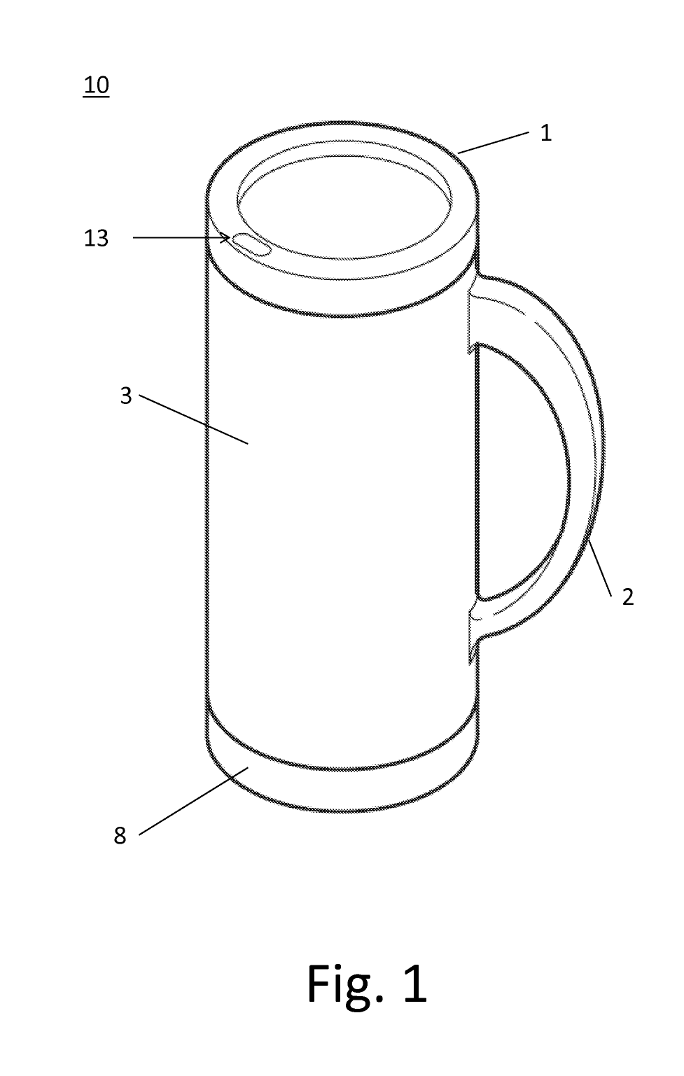

Now referring to the Figures, the embodiment of the container 10 with removable bottom tea infuser compartment 6 is illustrated. FIG. 1 is a perspective view of the container 10 of the present invention assembled and ready for use.

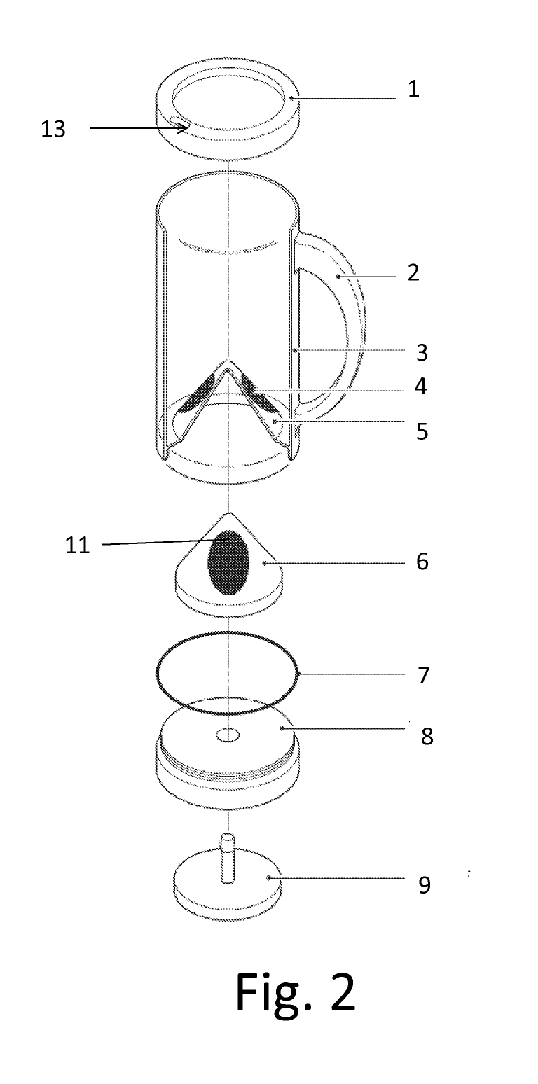

Now referring to FIG. 2 is an exploded view of the container 10 of the present invention illustrating all the components parts of the device and their order of assembly. The container 10 of the present invention is assembled from a shaft 3 with an interior and exterior surface, the exterior surface which may or may not have a handle 2 molded or affixed to it. The interior surface of the shaft 3 defines the liquid storage area from which a person would drink a liquid. The top of the shaft 3 may or may not be covered with a top cap 1. In FIG. 2, the top cap 1 covers the opening of the drinking end of the shaft 3 and the top cap 1 is further comprised of a small drinking opening 13 similar to other caps 1 known in the prior art for hot liquids such as tea or hot chocolate. The opposing end of the shaft 3 from the drinking or top end is the base end. The base end is comprised of a tea compartment housing 5 which may or may not be molded into the shaft 3. The tea compartment housing 5 creates a space for a tea compartment to be retained when a base cap 1 is secured to the shaft 3. The tea compartment housing 5 is further comprised of wire mesh 4 which matches the shape of wire mesh 11 openings on the tea compartment 6. A threaded base cap 8 is secured to the base end of the shaft 3 by corresponding threads that allow it to be screwed into the base end of the shaft 3. The threaded base cap 8 includes a rubber seal 7 to stop leaks of the liquid placed within the shaft 3. The threaded base cap 8 is further comprised of the tea compartment 6 attached on one end, which, when the base cap 8 is attached to the shaft 3, protrudes into the tea compartment housing 5. The tea compartment housing 5 and tea compartment 6 are shown as cone shaped, but can be made of any shape that allows the tea compartment 6 to rotate freely within the tea compartment housing 5 for aligning the mesh wire openings 4 and 11 as controlled by an on/off control switch 9 that is affixed to an opposing side of the base cap 8.

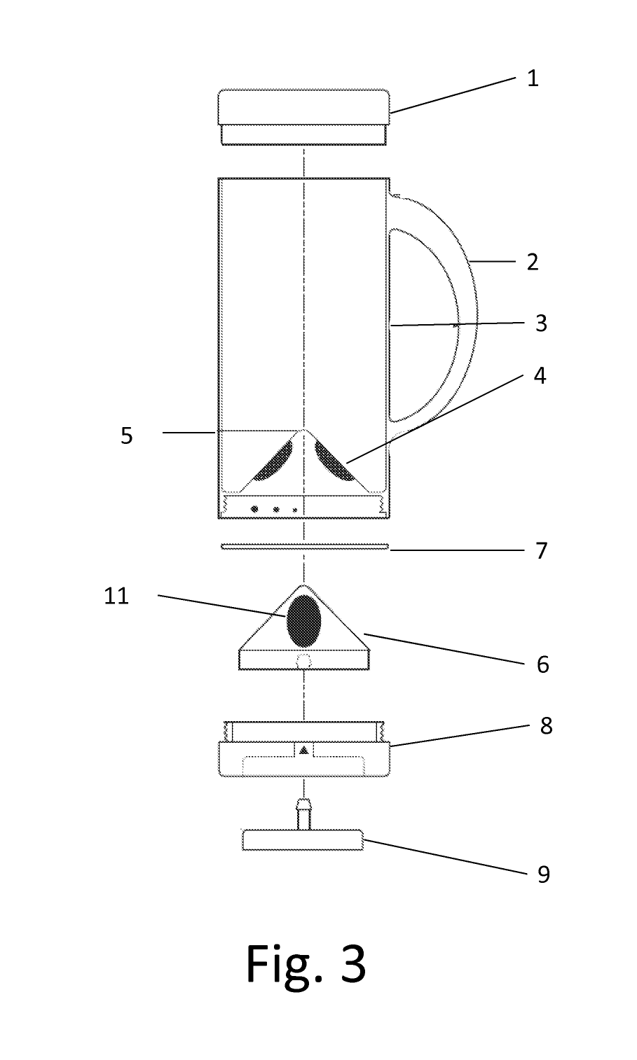

FIG. 3 is planar exploded view of the container 10 of the present invention illustrating the components of the parts of the device. It is recognized that a mere change of dimensions would be obvious to one of ordinary skill in the art.

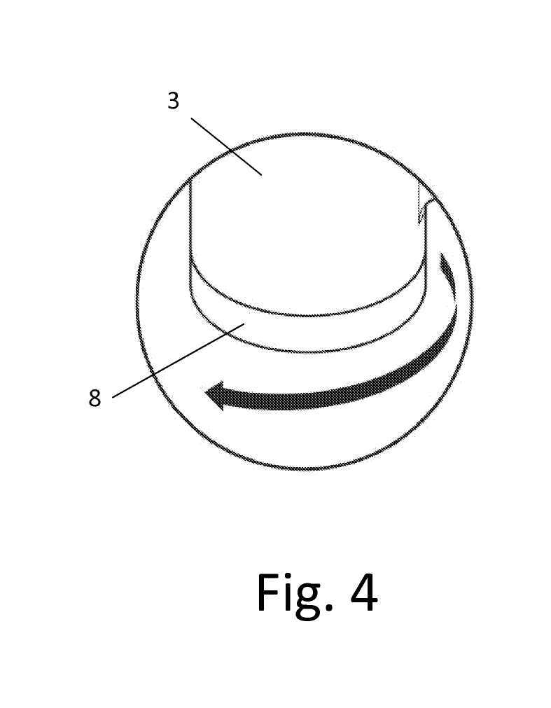

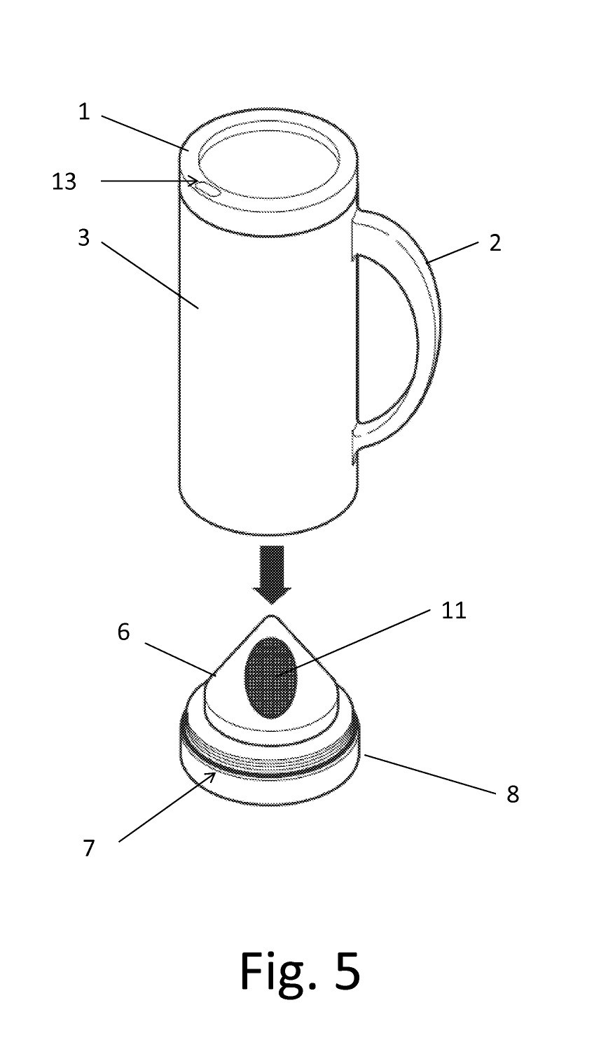

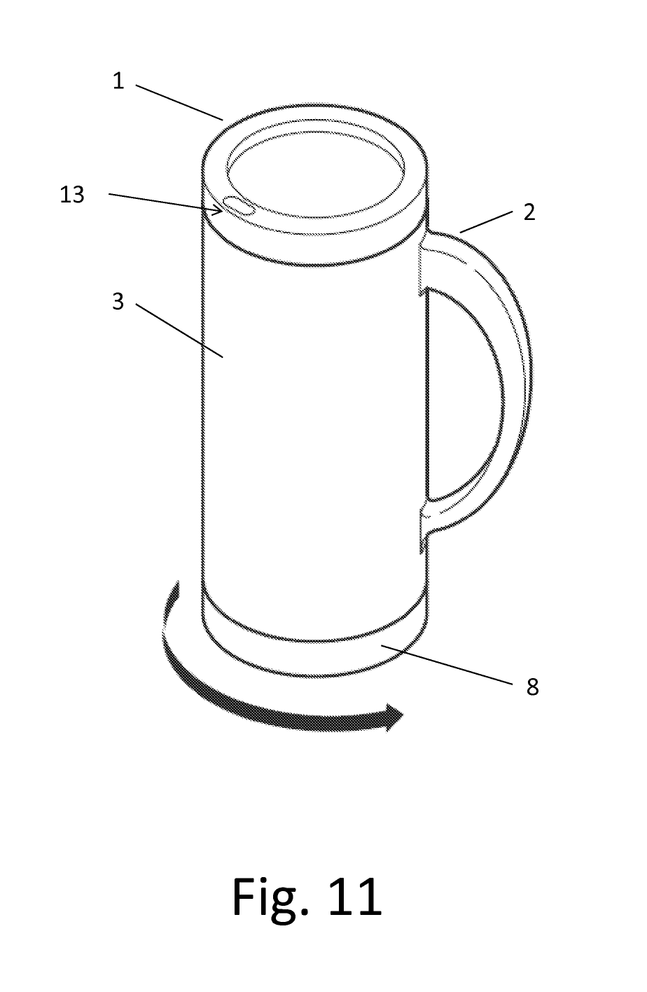

Now referring to FIG. 4, the base cap 8 is secured to the end of the shaft 3 by twisting clock-wise as viewed from the bottom of the shaft 3. The base cap 8 is removed from the shaft 3 by twisting counter clock wise as viewed from the bottom of the shaft 3. FIG. 5 shows the base cap 8 being removed from the end of the shaft 3 after unscrewing in a counter clock-wise direction a viewed from the bottom of the shaft 3 as shown in FIG. 11.

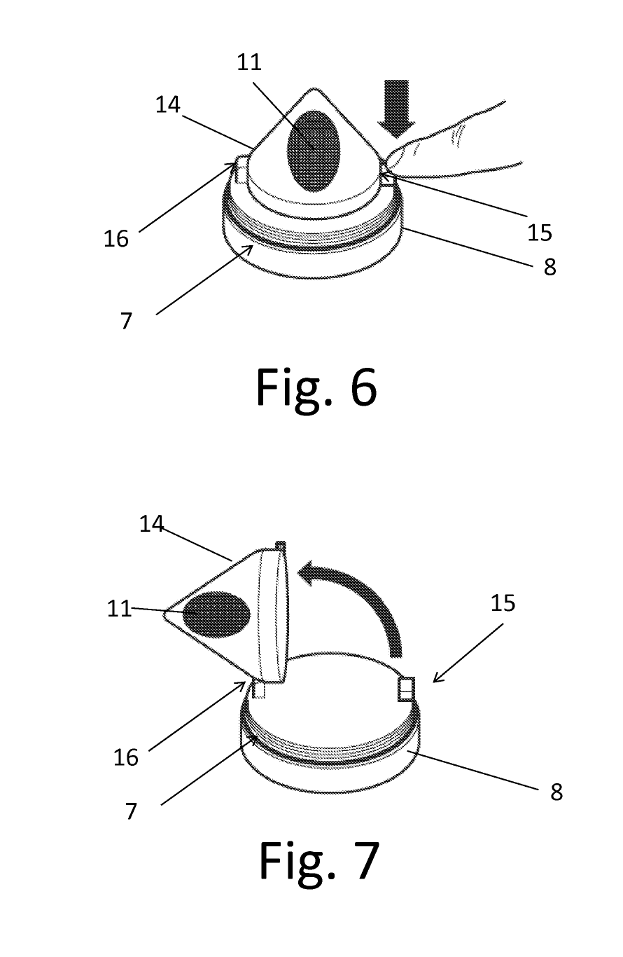

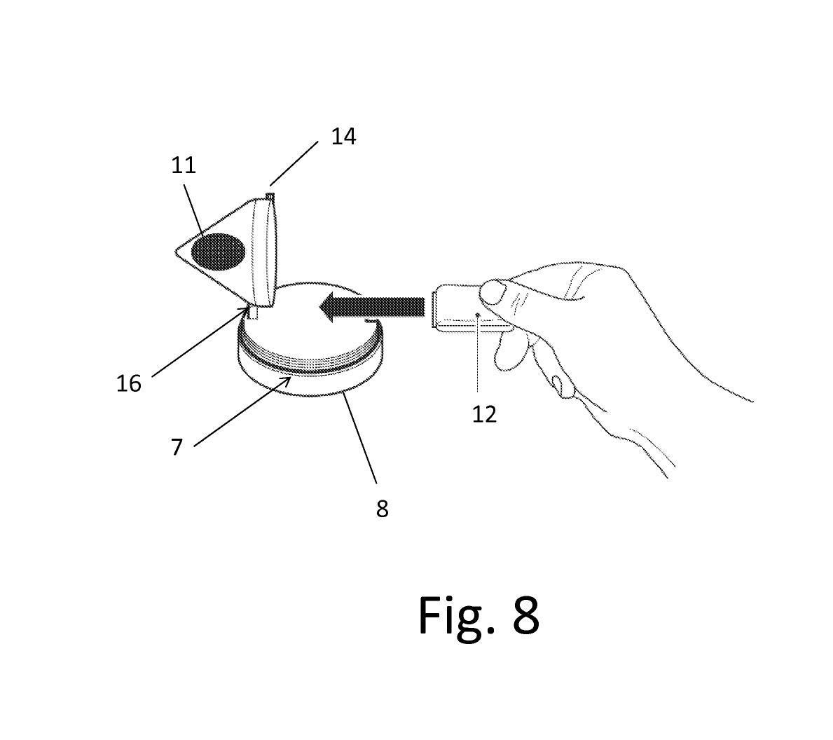

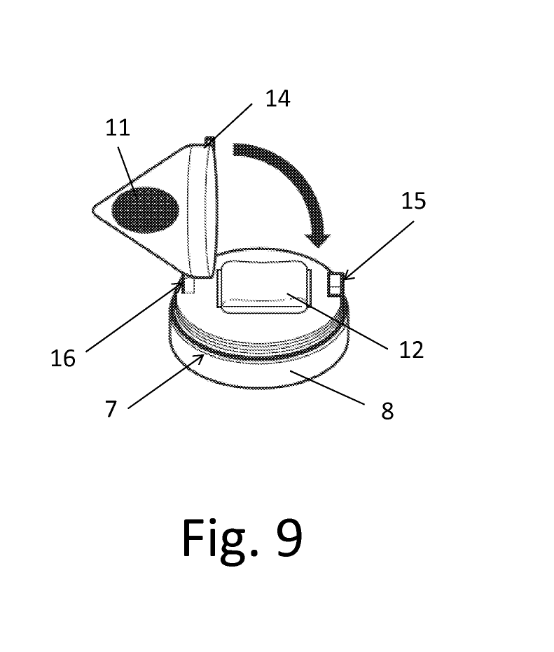

FIGS. 6-8 illustrate the operation of the tea compartment 6 cone. FIG. 6 illustrates the cone 6 released from a closed position by a user placing a finger on a snap release 15 and releasing the cone 14. In FIG. 7, the cone 14 is showed being rotated to an open position by a fixed hinge 16 attached to the cone 14, opposite the snap release/closure 15. When the cone 14 is in an open position a tea bag 12 or tea leave can be placed on the top surface of the bottom cap 8 and within the cone 14 as shown in FIG. 8. After the tea bag 12 or tea leaves have been placed on the bottom cap 8 and within the cone 14, the cone 14 is closed and snapped back into place as shown in FIG. 9.

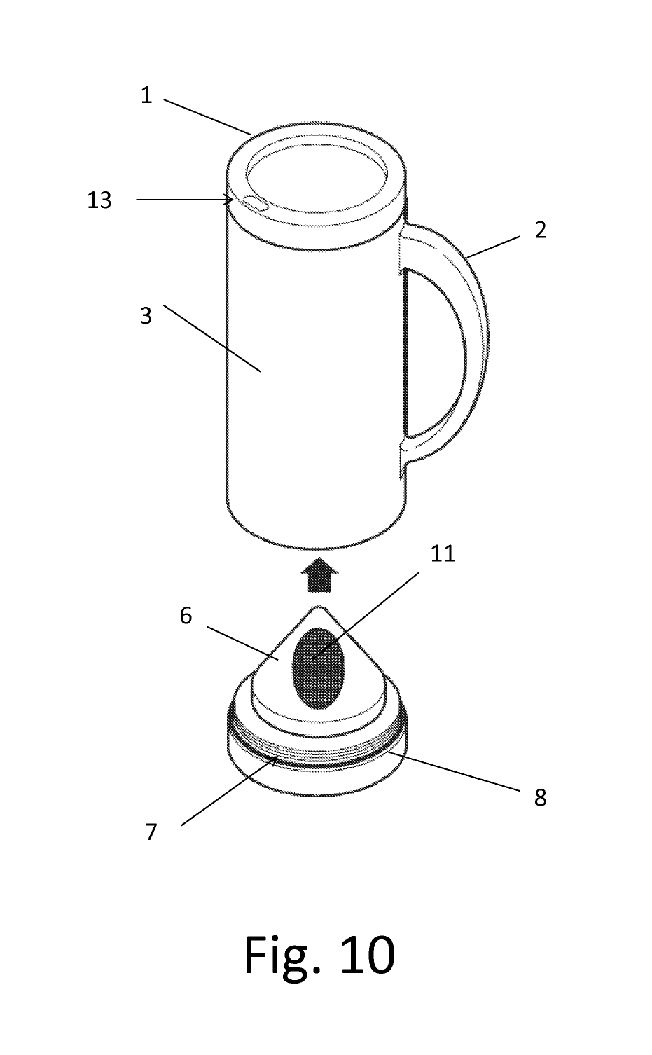

After the bottom cap 8 and corresponding cone 14 have been loaded, the bottom cap 8 is screwed back into the shaft 3 and secured into place as shown in FIG. 10. A rubber seal 7 is placed on the bottom cap 8 to ensure there are no leaks of the liquid placed within the open area inside the shaft 3 closed and sealed off by the bottom cap 8. The bottom cap 8 is secured to the bottom of the shaft 3 by corresponding threads on the two components by turning the bottom cap 8 clockwise with as viewed from the bottom of the shaft 3 as shown in FIG. 4.

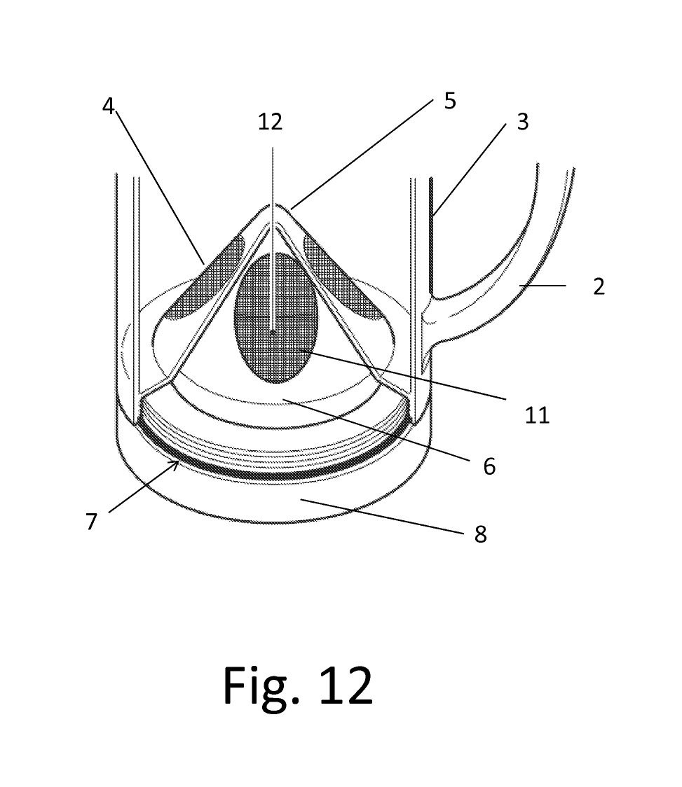

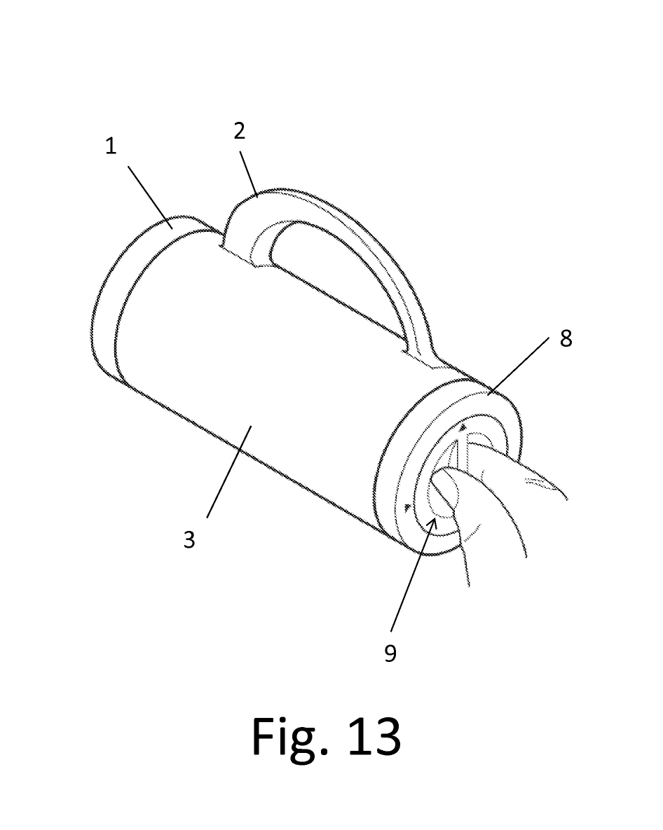

Now referring to FIG. 12 the base cap 8 attached to the shaft 3 and the tea bag 12 located inside the cone 14 and the mesh openings 11 of the tea bag 12 compartment 6 and the mesh openings 4 of the tea bag 12 compartment housing 5 are not aligned so that the tea bag 12 located in the cone 14 and any liquid, such as hot water, that may be in the shaft 3 are not able to mix or engage each other. The on/off control 9 is in a closed position as shown in FIG. 13 which corresponds to the mesh openings 4 and 11 being completely out of alignment.

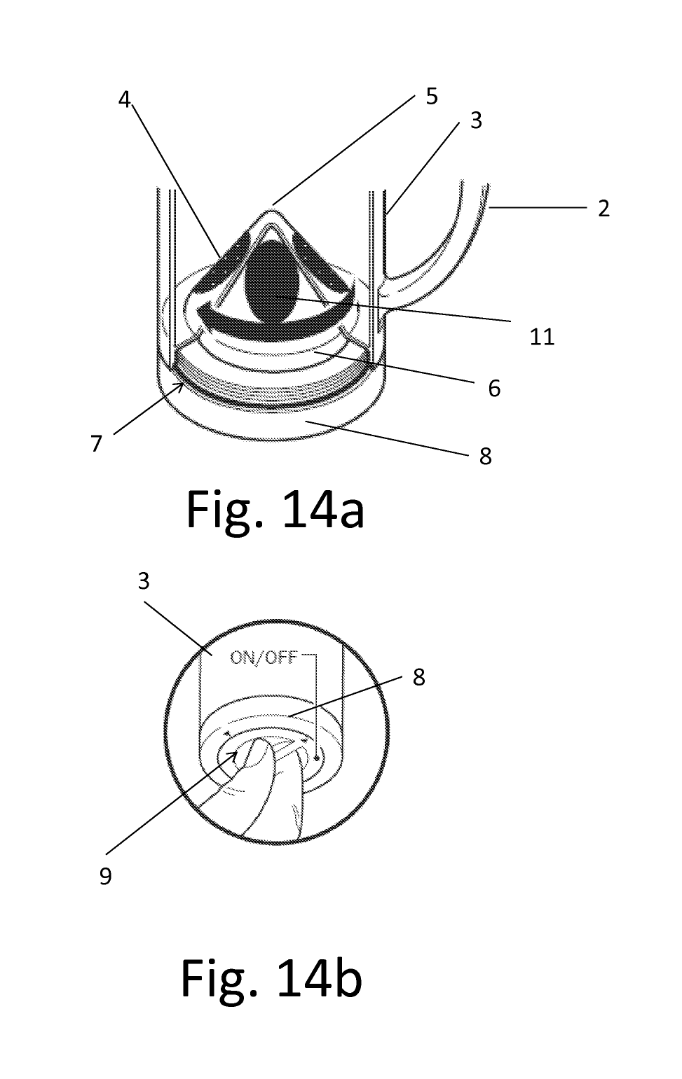

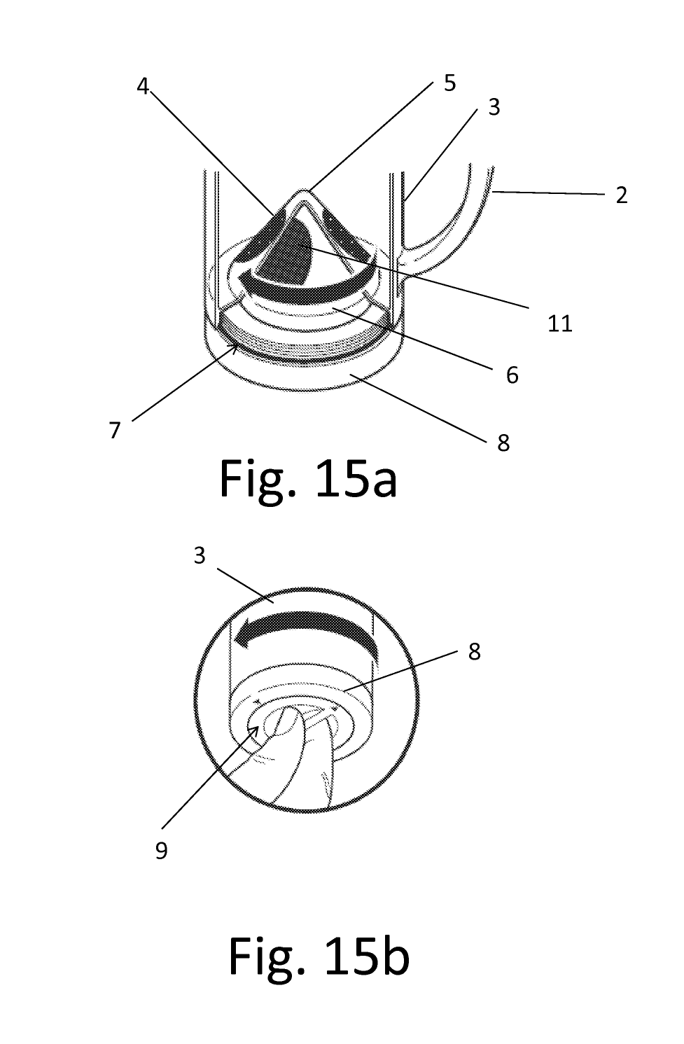

FIG. 14a is a perspective, cut away view, illustrating the relationship between the tea compartment 6 and tea compartment housing 5 of the shaft 3 when the on/off control 9 is placed in a closed/off position as shown in FIG. 14b. As the on/off control 9 is moved from a closed position to an open position by being turned in a counter clock-wise motion as viewed from the bottom of the base cap 8 as shown in FIG. 15b, the tea compartment 6 is correspondingly rotated within the tea compartment housing 5 and the mesh openings 11 of the tea compartment 6 and the mesh openings 4 of the tea compartment housing 5 begin to overlap as shown in FIG. 15a, allowing the liquid from within the shaft 3 to enter the tea compartment 6 and mix or steep with the tea bag 12 retained within the cone 14 of the tea compartment.

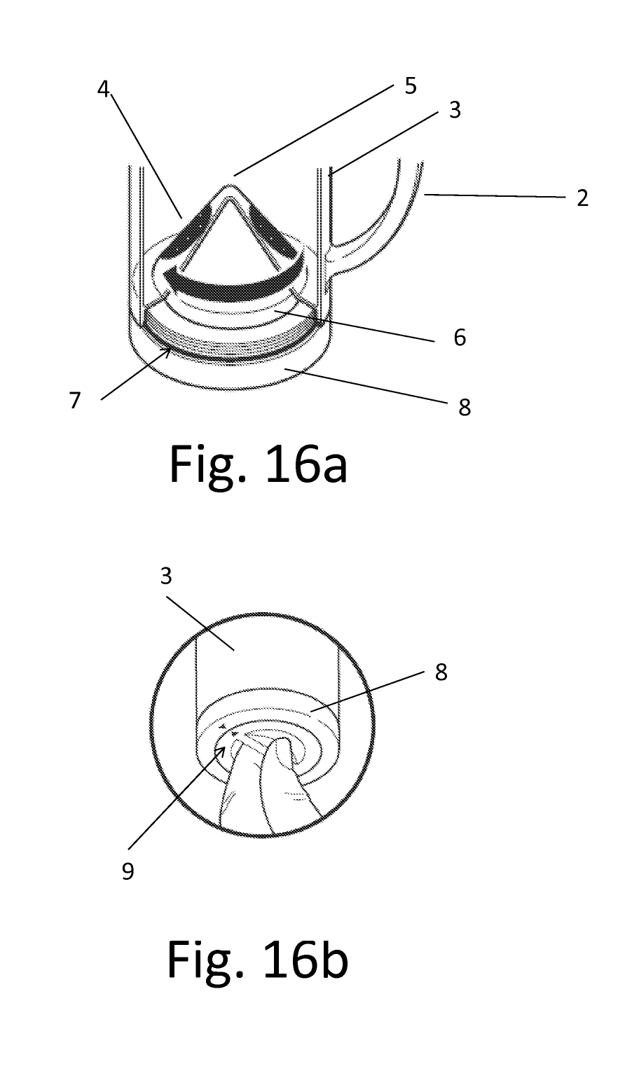

FIG. 16a illustrates the relationship between the mesh openings 11 of the tea compartment 6 and the mesh openings 4 of the tea compartment housing 5 of the shaft 3 when the on/off control 9 is placed in an open/on position as shown in FIG. 16b. As shown in FIG. 16a, when in the fully open position, the mesh openings 4 of the tea compartment housing 5 and the cone 14 of the tea compartment 6 and its mesh openings 11 are perfectly aligned allowing a free flow of the liquid into the cone 14 and tea bag 12 compartment.

Steeping occurs when the tea compartment 6 is rotated from a closed to open position where the hot water retained within the shaft 3 is allowed to mix with the tea bag 12 or tea leaves retained within the cone 14. Steeping typically takes 3-4 minutes to complete. When steeping is complete, the on/off control 9 on the bottom cap 8 is twisted clock-wise as viewed from the bottom of the base cap 8 to a closed position where, the mesh openings 4 of the tea compartment housing 5 and the mesh openings 11 of the tea compartment 6 are out of alignment so that no further interaction or mixing of the liquid and tea bag 12 occurs. The bottom cap 8 of the present invention enables the control of steeping while also providing a means of storage for a used tea bag 12 until a more convenient time for disposal occurs.

Thus, it is appreciated that the optimum dimensional relationships for the parts of the invention, to include variation in size, materials, shape, form, function, and manner of operation, assembly and use, are deemed readily apparent and obvious to one of ordinary skill in the art, and all equivalent relationships to those illustrated in the drawings and described in the above description are intended to be encompassed by the present invention.

Furthermore, other areas of art may benefit from this method and adjustments to the design are anticipated. Thus, the scope of the invention should be determined by the appended claims and their legal equivalents, rather than by the examples given.

The embodiments of the invention in which an exclusive property or privilege is claimed are defined as follows:

1. A container for brewing tea comprising:
a shaft with a top and base end portion and a liquid storage area defined by its interior surface;
the base end is comprised of a tea compartment housing;
the tea compartment housing creates a space for a tea compartment to be retained when a base cap is secured to the shaft;
the tea compartment housing is further comprised of one or more wire mesh openings;
a threaded base cap is secured to the base end of the shaft by corresponding threads that allow it to be screwed into the base end of the shaft;
the threaded base cap is further comprised of the tea compartment attached on one end, which, when the base cap is attached to the shaft, protrudes into the tea compartment housing;
the tea compartment is further comprised of one or more wire mesh opening which matches the number and shape of wire mesh openings on the tea compartment housing; and
an on/off control switch that is affixed to an opposing side of the base cap for rotating the tea compartment for aligning the mesh wire openings of the tea compartment and tea compartment housing.

2. The container of claim 1, further comprising a handle affixed to the outer surface of the shaft.

3. The container of claim 1, wherein the tea compartment housing and tea compartment are the same shaped.

4. The container of claim 3, wherein the tea compartment housing and tea compartment are cone shaped.

5. The container of claim 1, wherein the base end is comprised of a tea compartment housing may or may not be molded into the shaft;

6. The container of claim 1, further comprising a top cap affixed to a top end of the shaft, the top cap covers the opening of the drinking end of the shaft and the top cap is further comprised of a drinking opening.

7. The container of claim 1, further comprising a top cap removably affixed to a top end of the shaft.

8. The container of claim 6, wherein the top cap covers the opening of the drinking end of the shaft and the top cap is further comprised of a drinking opening.

9. The container of claim 1, wherein
the base cap is secured to the end of the shaft by twisting clock-wise as viewed from the bottom of the shaft; and
the base cap is removed from the shaft by twisting counter clock wise as viewed from the bottom of the shaft.

10. The container of claim 1, further comprising
a rubber seal attached to the threaded base cap to stop leaks of the liquid placed within the shaft.

11. The container of claim 1, further comprising
a snap release and closure attached to the tea compartment cone; and
a fixed hinge attached to the tea compartment cone.

12. The container of claim 1, further comprising
a rubber seal attached to the threaded base cap to stop leaks of the liquid placed within the shaft.

13. The container of claim 11, wherein
the tea compartment cone is released from a closed position by a placing pressure on the snap release and releasing the cone, which rotates to an open position about the fixed hinge for loading of a tea bag.

14. The container of claim 1, wherein
the base cap attached to the shaft and the mesh openings of the tea bag compartment and the mesh openings of the tea bag compartment housing are not aligned so that a tea bag located in the cone and any liquid in the shaft are not able to mix or engage each other; and
the on/off control is in a closed position which corresponds to the mesh openings 4 and 11 being completely out of alignment.

15. The container of claim 14, wherein
as the on/off control is moved from a closed position to an open position by being turned in a counter clock-wise motion as viewed from the bottom of the base cap;
the tea compartment is correspondingly rotated within the tea compartment housing and the mesh openings of the tea compartment and the mesh openings of the tea compartment housing begin to overlap; and
allowing the liquid from within the shaft to enter the tea compartment and mix or steep with the tea bag retained within the tea compartment.

16. The container of claim 15, wherein
when in the fully open position, the mesh openings of the tea compartment housing and the cone of the tea compartment and its mesh openings are perfectly aligned allowing a free flow of the liquid into the tea compartment.

17. The container of claim 16, wherein
when steeping is complete, the on/off control on the bottom cap is twisted clock-wise as viewed from the bottom of the base cap to a closed position where, the mesh openings of the tea compartment housing and the mesh openings of the tea compartment are out of alignment so that no further interaction or mixing of the liquid and tea compartment occurs.

18. The container of claim 13, wherein the bottom cap enables the control of steeping while also providing a means of storage for a used tea bag until a more convenient time for disposal occurs.

19. A container for brewing tea comprising:
a shaft with a top and base end portion and a liquid storage area defined by its interior surface;
the base end is comprised of a tea compartment housing which may or may not be molded into the shaft;
the tea compartment housing creates a space for a tea compartment to be retained when a base cap is secured to the shaft;
the tea compartment housing is further comprised of one or more wire mesh openings;
the threaded base cap is secured to the base end of the shaft by corresponding threads that allow it to be screwed into the base end of the shaft;
the threaded base cap includes a rubber seal to stop leaks of the liquid placed within the shaft;
the threaded base cap is further comprised of the tea compartment attached on one end, which, when the base cap is attached to the shaft, protrudes into the tea compartment housing;
the tea compartment is further comprised of one or more wire mesh opening which matches the number and shape of wire mesh openings on the tea compartment housing;
the tea compartment housing and tea compartment are cone shaped;
an on/off control switch that is affixed to an opposing side of the base cap for rotating the tea compartment for aligning the mesh wire openings of the tea compartment and tea compartment housing; and
a top cap removably affixed to a top end of the shaft, the top cap covers the opening of the drinking end of the shaft and the top cap is further comprised of a small drinking opening.

20. The container of claim 19, further comprising a handle affixed to the outer surface of the shaft.
